(19) United States
(12) Patent Application Publication
(10) Pub. No.: US 2009/0070745 A1
(43) Pub. Date: Mar. 12, 2009

(54) SYSTEM AND CORRESPONDING METHOD FOR TESTING SOFTWARE EMBEDDED IN AN ELECTRONIC DEVICE

(76) Inventors: MARK EVERLY, Palm Bay, FL (US); Bruce Hanson, Melbourne, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 12/203,489

(22) Filed: Sep. 3, 2008

Related U.S. Application Data
(60) Provisional application No. 60/969,776, filed on Sep. 4, 2007.

(51) Int. Cl. G06F 9/44

(52) U.S. Cl. 717/128

(57) ABSTRACT

A system includes an electronic device and an external tester to be temporarily coupled thereto. The electronic device includes an integrated circuit processor. The integrated circuit processor includes processor circuitry for executing dedicated code to perform a dedicated application, and an execution unit coupled to the processor circuitry. The external tester is to be temporarily coupled to the execution unit to collect execution characteristics while the processor circuitry executes the dedicated code to thereby test the dedicated code.

### RELATED APPLICATION

This application claims the benefit of U.S. Provisional Application Ser. No. 60/969,776 filed Sep. 4, 2007, the entire contents of which are incorporated herein by reference.

### FIELD OF THE INVENTION

The present invention relates to the field of software testing, and more particularly, to testing the structural coverage of software embedded in an electronic device.

### BACKGROUND OF THE INVENTION

In the field of aeronautics, standards such as RTCA/DO-178 call for strict tests when validating embedded software within an electronic device to be operated within an aircraft. This standard calls for complete structural coverage of the software at the level of instructions and decisions. In other words, when implementing the software, all software instructions should be executed and, potentially, all decisions need to have taken all possible choices.

The electronic device may typically be a special purpose computer system designed to perform one or more dedicated functions. As an example, the electronic device may be a communications radio, a flight control computer or an altimeter. The electronic device may contain one or more microprocessors executing one or more dedicated embedded software applications. The embedded software applications access devices such as memory or input/output devices. These devices may be accessed directly or indirectly by the microprocessor.

One approach for obtaining structural coverage involves software instrumentation. Software instrumentation involves modifying each code structure with additional executable statements that provide an external indication of executed code structures. This external indication is typically a unique attribute for each code structure that is transmitted from the unit under test to an external data collection device such as a logic analyzer or custom data collection apparatus. Each attribute is then reconciled with the “instrumented” source code to provide an indication of executed code structures.

A disadvantage of software instrumentation is that additional source code and required support libraries are added to the baseline software to support instrumentation. These additional facilities require additional program memory above that required for the baseline software. Typical instrumentation of source code requires an additional 50% to 150% allocation of program memory resources. As cost is a key factor, the design process typically tries to reduce the size of program memory resources to reduce standard production costs and not carry this cost throughout the product life-cycle. Another disadvantage is that program execution characteristics are modified as a result of the instrumentation overhead.

Another approach for obtaining structural coverage involves collecting execution data from the external microprocessor address, data and control buses. In this approach a device, such as a logic analyzer, is coupled to the address bus of the microprocessor. Execution addresses are then compared against the object code created by the software compiler and linker. For example, U.S. Patent Application No. 2007/0239959 discloses a device for testing the structural coverage of a software program. The software, stored in a first memory, comprises instructions that can be located via addresses on an address bus connecting the processor to the first memory. The device includes a second memory connected to the address bus that can be used to store values in memory associated with each address. These values indicate the conditions for calling up the associated address by the processor. The contents of the second memory are erased, tests validating the software are performed, and the contents of the second memory are compared with a list of addresses where instructions are located.

While this implementation is viable for a relatively straightforward microprocessor, it is not applicable to a microprocessor that implements an instruction pre-fetch and cache mechanism to optimize execution time. Rather than reading execution instructions from program memory as they are executed, instructions are read in advance of execution and discarded if execution flow does not require the pre-fetch instructions. It is thus possible that a pre-fetch can erroneously provide coverage data. In addition, many microprocessors internally implement program memory, and do not provide a way to externally expose the execution addresses.

Yet another approach for obtaining structural coverage is to execute the software application, or portions of the application, on a simulator hosted on a computer other than the target computer. This approach may typically be used to perform testing at a software function level (unit level testing) to ensure the integrity of areas of functionality such as mathematic formulas. One limitation of this approach is that the instrumentation modifies the software, and therefore, is subject to the same issues as in the above described software instrumentation approach.

This simulator approach is illustrated in U.S. Patent Application No. 2007/0094001, for example. A microprocessor is configured to notify an information collection module when a branch is taken, and a branch address is recorded when the information collection module is notified of a branch taken. The recorded branch addresses are stored to determine code coverage of a target program. In particular, the target program is run on a virtual machine. Even though this approach provides a non-instrumented approach to code coverage analysis, the software is executed in a virtual machine rather than the actual embedded target. While this approach determines the structural coverage against the target software, execution in a device other than the actual target creates a significant risk of differences in execution since the virtual machine is at best a simulation of the actual target environment.

### SUMMARY OF THE INVENTION

In view of the foregoing background, it is therefore an object of the present invention to perform code analysis on software embedded within an electronic device, with execution characteristics being collected from the electronic device in a manner that is non-intrusive to the operation of the electronic device.

This and other objects, features, and advantages in accordance with the present invention are provided by a system comprising an electronic device and an external tester to be temporarily coupled thereto. The electronic device may comprise an integrated circuit processor. The integrated circuit processor may comprise processor circuitry for executing dedicated code to perform a dedicated application, and an execution unit coupled to the processor circuitry. The external tester is to be temporarily coupled to the execution unit to collect a plurality of execution characteristics while the processor circuitry executes the dedicated code to thereby test the dedicated code.

The external tester may collect the execution characteristics in real-time. In one embodiment, the integrated circuit processor may further comprise a program memory for storing the dedicated code. In another embodiment, the electronic device may further comprise a program memory for storing the dedicated code.

The processor circuitry may comprise a plurality of registers, and the execution unit may access the plurality of registers. In particular, the execution unit may include at least one register output and an address bus output, with the tester being temporarily coupled thereto. The address bus output may provide an address corresponding to an instruction being executed, and the at least one register output may provide a flag corresponding to the executed instruction.

The integrated circuit processor is advantageously manufactured to permit the execution unit to expose execution characteristics while the processor circuitry executes the dedicated code to thereby test the dedicated code. This may be readily applicable to testing the structural coverage of software embedded in an electronic device, as well as performing non-structural coverage analysis, such at timing, etc. The modified integrated circuit processor thus allows real-time code analysis to be performed. This is done in a non-intrusive manner to the operational characteristics of the electronic device.

The external tester may comprise an execution decode unit for decoding the collected execution characteristics, and an execution analysis unit coupled to the execution decode unit for analyzing the decoded execution characteristics. The execution analysis unit may compare the decoded execution characteristics to the code being executed by the processor circuitry. The external tester may further comprise an execution control unit coupled to the execution unit and to the execution decode unit for control thereof.

Another aspect of the present invention is to provide a method for testing an electronic device as described above. The method may comprise temporarily coupling the external tester to the execution unit, and using the external tester to collect a plurality of execution characteristics while the processor circuitry executes the dedicated code stored in the program memory to thereby test the stored dedicated code.

### BRIEF DESCRIPTION OF THE DRAWINGS

FIG. 1 is a block diagram of a modified CPU processor unit with a single CPU, and an instruction collection apparatus coupled thereto in accordance with the present invention.

FIG. 2 is a block diagram of a modified CPU processor unit with more than one CPU, and an instruction collection apparatus coupled thereto in accordance with the present invention.

FIG. 3 is a partial block diagram of a modified CPU processor unit illustrating access lines for providing external access without disturbing normal CPU pins in accordance with the present invention.

FIG. 4 is top view of the modified CPU processor unit mounted to an access board that provides contact to the access lines in accordance with the present invention.

FIG. 5 is a side view of the modified CPU processor unit mounted to the access board as shown in FIG. 4.

FIG. 6 is a block diagram of a modified CPU processor unit with more than one CPU and including a multiplexer coupled to the normal CPU pins and to the access lines, and an external tester coupled thereto in accordance with the present invention.

FIG. 7 is a block diagram of an electronic device and an external tester coupled thereto in accordance with the present invention.

FIG. 8 is a block diagram illustrating an interface within the external tester between the execution decode unit and the execution memory unit in accordance with the present invention.

FIG. 9 is a flow chart illustrating a method for testing an electronic device in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and double prime notations are used to indicate similar elements in alternative embodiments.

As will now be discussed in greater detail, a test system includes hardware and software computing elements for intercepting execution of a target hardware for the purpose of verifying the quality of the target hardware. The test system collects and records the functional behavior of the target hardware using a methodology that does not change the operational characteristics of the target hardware.

The test system may reflect in real-time the actual execution of the target hardware. This level of verification in real-time for embedded computer applications is critical for certain industry applications, such as, but not limited to, the aeronautical field. Execution attributes are collected from the target hardware. Example attributes include address lines, data lines and control lines of the microprocessor in the target hardware. Other attributes may be collected, as readily appreciated by those skilled in the art. The actual execution attributes of the target hardware are thus exposed in real-timer and these attributes are then collected, stored and analyzed. These attributes may be exposed via an auxiliary, time-sliced bus or via individual outputs. In addition, reference to a microprocessor may be used interchangeably with a CPU.

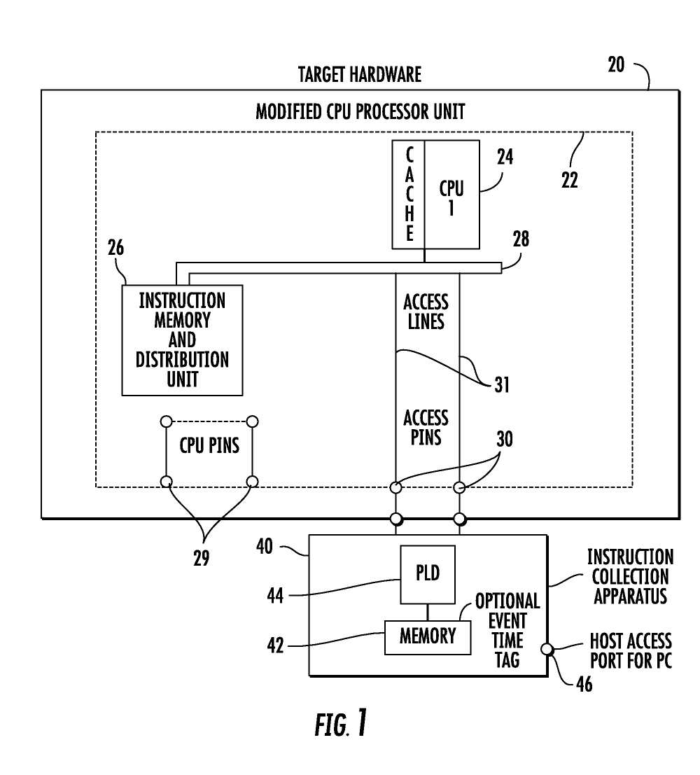

Referring now to FIG. 1, an example target hardware 20 or target system will be discussed. The target hardware 20 may be a printed circuit board including a modified CPU processor unit 22 thereon, the functions of which are controlled by a single CPU 24. The CPU 24 may be referred to as a target CPU. The CPU 24 interacts with an instruction memory and distribution unit 26 containing a stored program among other items. The modified CPU processor unit 22 includes a standard set of pins 29. A bus 28 is connected to the single CPU 24 and to the instruction memory and distribution unit 26. Access lines 31 are connected between the bus 28 and access pins 30 on the CPU processor unit 22 and on the target hardware 20 to an instruction collection apparatus 40. The instruction collection apparatus 40 may also be referred to as an external tester.

The instruction collection apparatus 40 includes a programmable logic device (PLD) 44 and memory 42 combination. The instruction collection apparatus 40 is accessible by a host access port 46 comprising one or more output lines. In use, a slow PC host can be used for analysis by off loading contents of the memory 42 at a speed that the PC can handle.

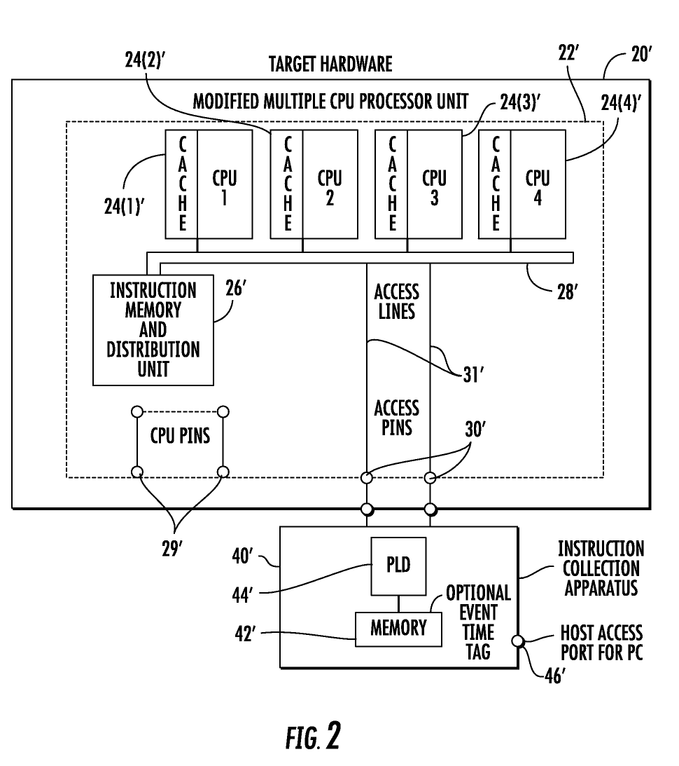

The modified CPU processor unit 22 in FIG. 1 may be configured to include a plurality of CPUs 24(1)′-24(4)′, as illustrated in FIG. 2. The four CPUs 24(1)′-24(4)′ are for illustrative purposes, and the actual number may vary depending on the intended application. In this case, the modified multiple CPU processor unit 22′ contains four CPUs 24(1)′-24(4)′, which are fed by an instruction memory and distribution unit 26′ that allocates instruction execution to the individual CPU's.

The modified multiple CPU processor unit 22′ may be modified to include access pins 30′ which connect to lines connected to similar or identical access pins on the target hardware 20′ which then connect to the instruction collection apparatus 40′ as discussed above. Optionally, the instruction collection apparatus 40′ may apply a time tag to various events as they occur during execution of the program. A host access port 46 comprising one or more outputs allow a host computer to retrieve from the memory 42 the events selectively stored therein by the PLD 44′. The access lines from the CPU bus 28′ connect a plurality of external pins which are separate from the normal CPU pins 29′ for the particular configuration of the illustrated multiple CPU processor unit 22′.

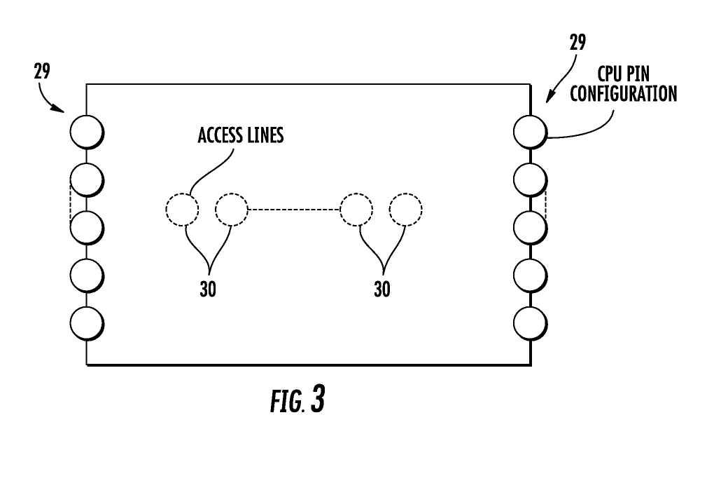

One way in which the modified CPU processor unit 22 can be modified to permit access lines 30 from the CPU 24 to be available to the external body of the chip in such a way that they do not interfere with the normal configuration of the CPU pins 29 is illustrated in FIG. 3. Of course, any variety of positioning may be selected depending on the application desired. What is important is that the normal configuration of the CPU pins 29 is not to be disturbed, and that the access lines 30 provide external access using pins separately provided for that purpose.

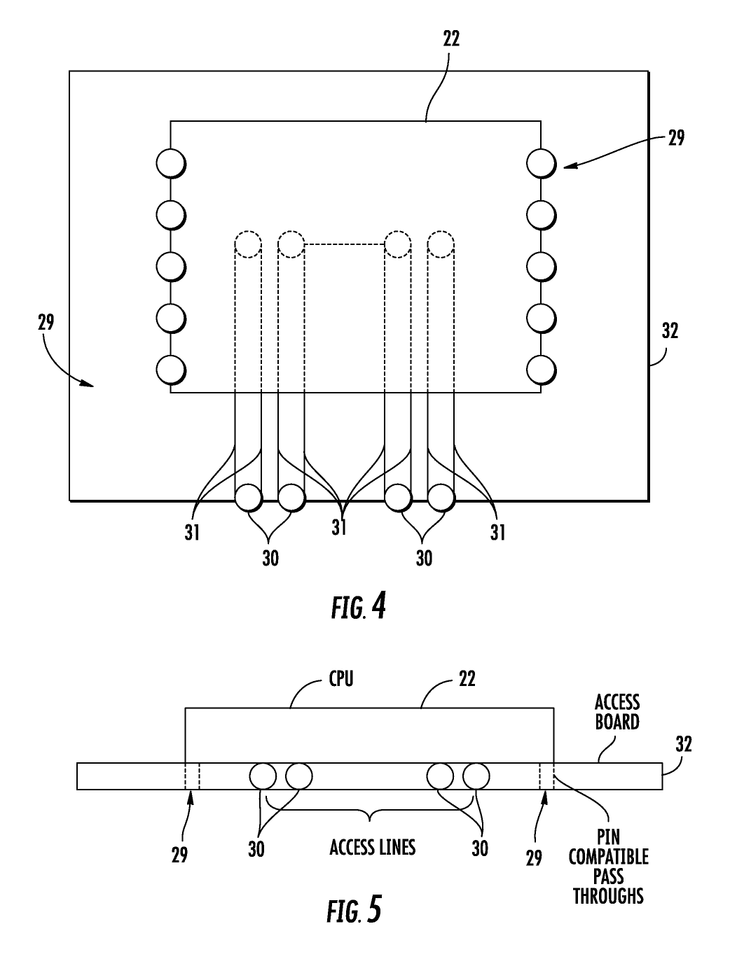

An example of this is shown in FIGS. 4 and 5. In FIG. 4, the modified processor unit 22 is shown mounted to an access board 32 in such a way that the access board provides contact to the access lines of the modified CPU processor unit 22. The normal CPU pins 29 are provided as straight pass throughs so that when the modified CPU processor unit 22 is removed from the access board 32, it can be mounted directly to the target hardware 20 once testing is complete. Alternatively, the modified CPU processor unit 22 may be tested after already being mounted to the target hardware 20.

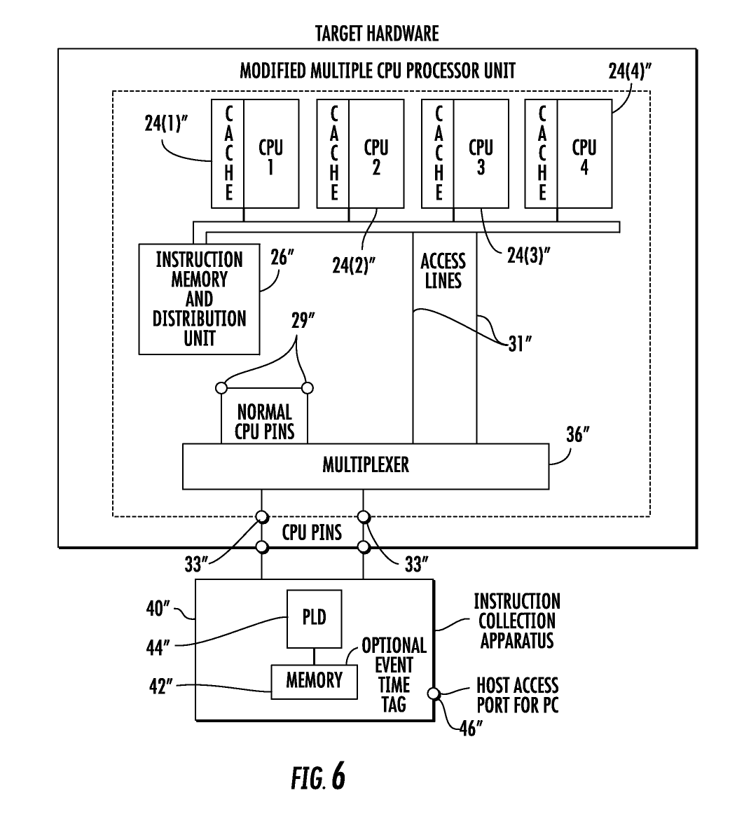

FIG. 6 shows a similar configuration in which the access lines 31″ which provide access to the events to be stored in the instruction collection apparatus 40″ can be multiplexed using a multiplexer 36″. The events can be multiplexed onto pins 33″.

Although code analysis, per se, is not a new innovation, real-time code analysis in accordance with the present invention, where execution characteristics/data are collected directly from the target system in a manner non-intrusive to the target system's operational characteristics, while mitigating issues related to pre-fetch, caching and other operational optimizations of the target system, is an advancement in the art. Current test system methodologies require modifications to the target system characteristics, both in software and hardware. This is advantageous on operational attributes, including, but not limited to, execution timing and memory allocation.

If the modified CPU processor unit 22 is deployed with built in facilities as described above, then modification to the test hardware is not required. If the modified CPU processor unit 24 is replaced for test purposes, the test CPU unit may then be designed as a form, fit and function replacement for the actual target modified CPU processor unit 24.

Benefits of the illustrated embodiments include the analysis and release code being identical in size, timing characteristics of the analysis and release code being identical, and execution path of analysis and release code being identical. The test system can be modified without altering the operational characteristics of the target hardware 20. As the embedded modified CPU processor unit 22 is identical to the released version, all operational characteristics of the target hardware 20 are identical. The test system can adjust the level of completeness and complexity of analysis without changing the target hardware 20. The target hardware 20 may be configured to provide all execution data. The filtering of the execution data may be performed by the instruction collection apparatus 40. The test system captures and correlates the functional attributes of the target hardware 20.

Advantages of the present invention thus include the following: expose actual execution attributes of a real-time computing system that does not alter its operational characteristics; passively collect the exposed execution attributes; a passive collection mechanism that excludes influences of pre-fetch, cache and optimization; a method to collect execution attributes over significant periods of time; a method to store the collected execution attributes according to a defined set of instructions; a method to analyze the stored execution attributes; a method to present the analyzed data; and a system that separates collection (includes setup, running, instrumentation . . . ) from analysis for the purpose of verifying the operational integrity of a real-time embedded computing system.

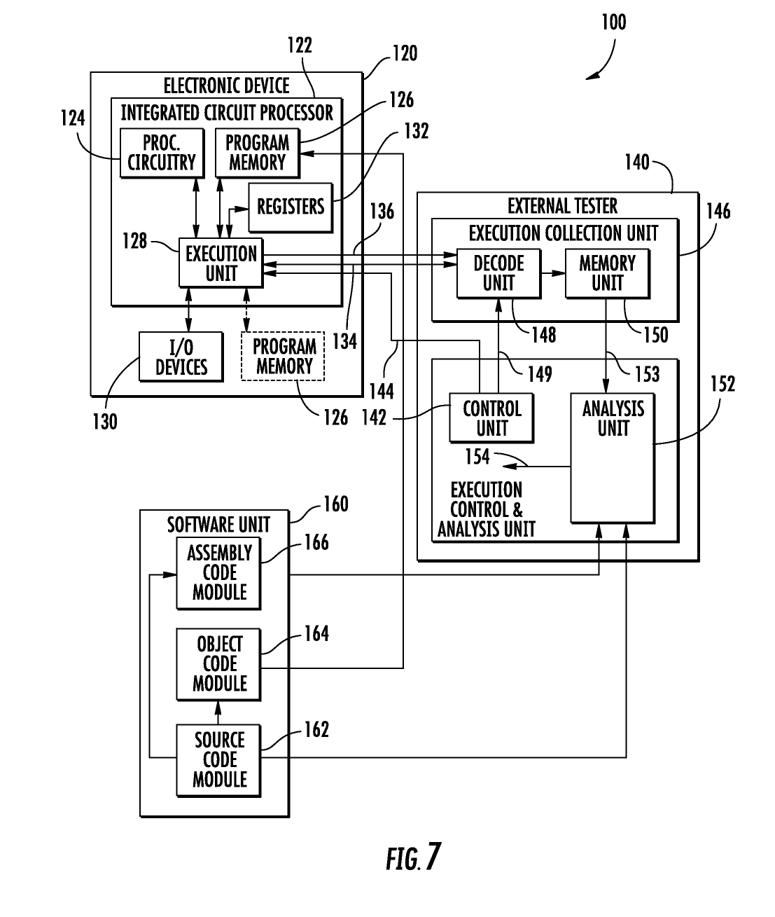

A system 100 that includes an electronic device 120 and an external tester 140 to be temporarily coupled thereto will now be discussed in greater detail in reference to FIG. 7. The electronic device 120 includes an integrated circuit processor 122. The integrated circuit processor 122 includes processor circuitry 124 for executing dedicated code to perform a dedicated application, a program memory 126 embedded with the processor circuitry for storing the dedicated code, and an execution unit 128 embedded with the processor circuitry and coupled thereto. The illustrated external tester 140 is coupled to the execution unit 128 to collect a plurality of execution characteristics while the processor circuitry 124 executes the stored dedicated code to thereby test the dedicated code. The external tester 140 collects the execution characteristics in real-time. In an alternative embodiment, the program memory 126 is separate from the integrated circuit processor 122, as illustrated by the dashed lines.

The electronic device 120 may further include at least one other device coupled to the integrated circuit processor, such as an input/output device 130, for example. The processor circuitry 124 includes a plurality of registers 132, and the execution unit 128 accesses the plurality of registers.

As will be discussed in greater detail below, the execution unit 128 includes at least one register output 134 and an address bus output 136 temporarily coupled to the external tester 140. The address bus output 136 may provide an address corresponding to an instruction being executed, and the at least one register output 134 may provide a flag corresponding to the executed instruction.

The electronic device 120 may be an embedded system, which is a special-purpose computer system designed to perform one or more dedicated functions, often with real-time computing constraints. An embedded system may be embedded as part of a complete device including hardware and mechanical parts. In contrast, a general-purpose computer, such as a personal computer, can do many different tasks depending on programming. An embedded system may control many of the common devices in use today. As noted above, an embedded system may include one or more embedded microprocessors or CPUs executing one or more dedicated embedded software applications. The embedded software applications access devices, such as memory or input/output devices. These devices may be located on the target computer or another external section of the embedded system and may be accessed either directly or indirectly by the CPU.

There is an exponential cost of software errors as life-cycle progresses. Structural coverage is advantageously used to determine if enough requirements specifying performance of the embedded software are present and if a sufficient level of testing, based on these requirements, has been performed. A quantifiable method is provided to determine when a prudent level of software testing has been performed, and this is advantageously done without requiring software instrumentation, nor multiple iterations of tests

A software unit 160 includes a source code module 162 for receiving the source code intended for the integrated circuit processor 122. The software unit 160 is configured for compiling and linking the source code in the source code module 162 to generate object code and assembly code. The object code is stored in an object code module 164, and the assembly code is stored in an assembly code module 166. The object code is loaded into the program memory 126. The assembly code associates the object code to the source code.

The integrated circuit processor 122 is advantageously manufactured to permit configuration of the execution unit 128 to expose attributes of the execution unit external to the processor. As readily understood by those skilled in the art, a microprocessor has internal registers 132 that are used to determine how the microprocessor should perform at a given decision statement. However, these registers are not externally exposed in real-time. Reference is directed to TABLE 1 providing an example assembly and object code.

TABLE 1

| execution address | object code | assembly code |
|---|---|---|
| 00000031 | 83 FB 05 | cmp ebx.5 |
| 00000034 | 0E 9D C0 | setge al |
| 00000037 | 0F B6 C0 | movzx eax, al |
| 0000003a | 8B F8 | mov ebx, eax |
| 0000003c | 85 FF | test edi, edi |
| 0000003e | 75 18 | jne 00000058 |

For illustration purposes, the microprocessor 122 may be allocated a “zero flag” in the execution unit 128. During a “test” instruction, the zero register is either set or cleared depending on a logical AND of the two instruction parameters.

In the example, line 000031 compares a value stored in register ebx to 5. A source code object, SequenceCounter, has been associated ti register ebx earlier. Line 000034 sets register al to 1 if ebx is greater than or equal to 5 or to 0 if ebx is less than 5. Lines 000037 and 00003a place the value of al in register edi. Line 00003c logically ANDs edi with itself and sets the zero flag accordingly. In this case, logically ANDing a value with itself will set the zero flag to 0 if the value is zero and will set the zero flag to 1 if the value is anything other than zero. Line 00003e then executes a jump if the zero flag is zero. If not, execution continues to the next instruction following instruction 00003e.

The integrated circuit processor 122 facilities exposure of the execution address via an address bus output 136 and the zero flag via a flag output 134. Depending on the instruction, other flag outputs are provided that include a sign flag, and a parity flag, for example. The modified integrated circuit processor 122 permits an unambiguous analysis of the exact path taken at any point during execution. The facilities would most likely come in the form of an additional parallel bus providing the execution address and the state of the zero flag. It is possible that each flag could have a dedicated output. It is also possible that only the necessary flags are output, depending on the executing instruction.

The external tester 140 includes an execution control unit 142 that configures the execution unit 128 via an execution control bus 144 to transmit appropriate attributes or execution characteristics on the at least one register output 134 and the address bus output 136 to an execution collection unit 146 in real-time as the integrated circuit processor 122 executes the loaded object code from the object code module 164 in the software unit 160. The execution control unit 142 may be configured to control which execution addresses, instruction types, flags and registers are transmitted from the integrated circuit processor 122. This allows control over the type and extent of the data.

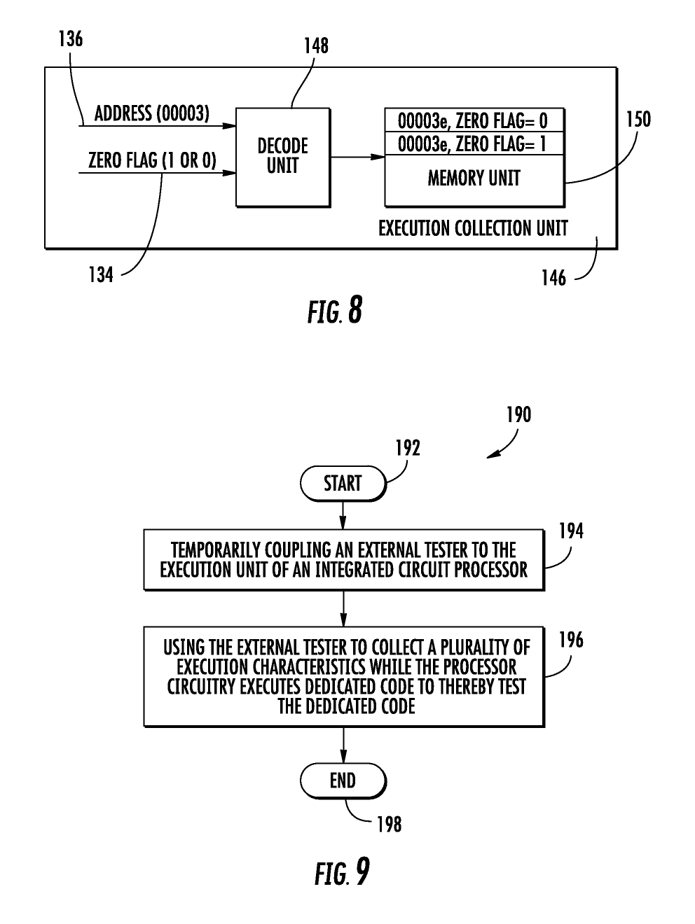

The execution control unit 142 configures an execution decode unit 148 via an execution decode control bus 149 to receive execution unit 128 attributes and store the attributes in an execution memory unit 150. Using TABLE 1 as an example, and with reference to FIG. 8, the execution control unit 142 would configure the execution decode unit 148 to store any occurrence of address 0003e and the zero flag. Two entries in the decode unit are needed. One for when the zero flag is 1, and the other for when the zero flag is 0. The decode unit 148 would then perform a decode. When an execution address of 00003e is received, the execution decode unit 148 resolves the instruction and the zero flag and configures the execution memory unit 150 to indicate the execution. Typically, all of the execution memory unit 150 would be initialized to 0 to indicate that no execution has occurred. As each instruction is decoded, the appropriate memory location would be set to 1.

An execution analysis unit 152 obtains attributes from the execution memory unit 150 via an execution results bus 153. Once the operator determines testing is complete, the execution analysis unit 152 reads the execution memory unit 150. The execution analysis unit 152 reconciles attributes against the embedded software assembly code provided by the assembly code module 166. In the case of TABLE 1, the value of the two execution memory locations attributed to execution address 00003e would be checked. If the first location is a 1, it would indicate that execution address 00003e occurred with the Zero flag set to 0. If the first location is a 0, it would indicate that execution address 00003e with the Zero flag set to 0 did not occur. The same is true for the second address with the same execution address, but the zero flag configured as a 1.

The execution analysis unit 152 reconciles the execution assembly code provided by the assembly code module 166 against the embedded source code provided by the source code module 162. Now that the execution history of execution address 00003e has been established, the results can now be reconciled against the source code. If the results show that execution address 00003e occurred with the zero flag both 0 and if the subject source code statement would be completely covered. If one, or both of the execution memory unit locations indicated that execution did not occur, the uncovered source code is annunciated.

The execution analysis unit 152 provides execution statistics via output 154. As an example, assume that execution address 00003e occurred with the zero flag set to 1, but not 0. The execution analysis unit 152 would provide the following report, for example:

Address Source Code
00003e if (SequenceCounter < 5)
Tt X
Ff
Tt indicates the following (X indicates that this
path is executed):
T - Indicates that the TRUE path of the source code
statement occurred
t - Indicates that the TRUE condition of the
SequenceCounter < 5 occurred
Ff indicates the following (No X indicates that this
path did not execute):
F - Indicates that the FALSE path of the source code
statement did not occur
f - Indicates that the FALSE condition of the
SequenceCounter < 5 did not occur

This is a rather simplistic example. In the case of multiple conditions, the indications could be rather complicated. For example, a source code constructed such as

if ((a < 10) and (b < 10)) would resolve to
Ttt - indicating that since both a and b were less
than 10 the TRUE path is taken
Fft - indicating that since a >= 10, the FALSE path
is taken
Ftf - indicating that since b >= 10, the FALSE path
is taken
Fft - indicating that since both a >= 10 and b >=
10, the FALSE path is taken

Referring now to FIG. 9, a flow diagram 190 illustrating a method for testing an electronic device 120 as described above will now be discussed. From the start (Block 192), the method comprises temporarily coupling an external tester 140 to the execution unit 128 at Block 194, and using the external tester to collect a plurality of execution characteristics while the processor circuitry 124 executes the dedicated code stored in the program memory 126 to thereby test the stored dedicated code at Block 196. The method ends at Block 198.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system comprising:
an electronic device and an external tester to be temporarily coupled thereto;
said electronic device comprising an integrated circuit processor, said integrated circuit processor comprising
processor circuitry for executing dedicated code to perform a dedicated application, and
an execution unit coupled to said processor circuitry; and
said external tester to be temporarily coupled to said execution unit to collect a plurality of execution characteristics while said processor circuitry executes the dedicated code to thereby test the dedicated code.

2. A system according to claim 1 wherein said external tester collects the plurality of execution characteristics in real-time.

3. A system according to claim 1 wherein said integrated circuit processor further comprises a program memory for storing the dedicated code.

4. A system according to claim 1 wherein said electronic device further comprises a program memory for storing the dedicated code.

5. A system according to claim 1 wherein said electronic device further comprises at least one other device coupled to said integrated circuit processor.

6. A system according to claim 5 wherein said at least one other device comprises an input/output device.

7. A system according to claim 1 wherein said processor circuitry comprises a plurality of registers; and wherein said execution unit accesses said plurality of registers.

8. A system according to claim 1 wherein said execution unit comprises at least one register output and an address bus output; and wherein said external tester is temporarily coupled thereto.

9. A system according to claim 8 wherein the address bus output provides an address corresponding to an instruction being executed, and the at least one register output provides a flag corresponding to the instruction being executed.

10. A system according to claim 1 wherein said external tester comprises:
an execution decode unit for decoding the collected execution characteristics; and
an execution analysis unit coupled to said execution decode unit for analyzing the collected execution characteristics.

11. A system according to claim 10 wherein said execution analysis unit compares the decoded execution characteristics to the code being executed by said processor circuitry.

12. A system according to claim 10 wherein said external tester further comprises an execution control unit coupled to said execution unit and to said execution decode unit.

13. A system comprising:
an electronic device and an external tester to be temporarily coupled thereto;
said electronic device comprising an integrated circuit processor, said integrated circuit processor comprising
processor circuitry for executing dedicated code to perform a dedicated application,
a program memory for storing dedicated code to perform a dedicated application, and
an execution unit coupled to said processor circuitry and to said program memory; and
said external tester to be temporarily coupled to said execution unit to collect in real-time a plurality of execution characteristics while said processor circuitry executes the dedicated code to thereby test the stored dedicated code.

14. A system according to claim 13 wherein said electronic device further comprises an input/output device coupled to said integrated circuit processor.

15. A system according to claim 13 wherein said processor circuitry comprises a plurality of registers; and wherein said execution unit accesses said plurality of registers.

16. A system according to claim 13 wherein said execution unit comprises at least one register output and an address bus output; and wherein said external tester is temporarily coupled thereto.

17. A system according to claim 16 wherein the address bus output provides an address corresponding to an instruction being executed, and the at least one register output provides a flag corresponding to the instruction being executed.

18. A system according to claim 13 wherein said external tester comprises:
an execution decode unit for decoding the collected execution characteristics; and
an execution analysis unit coupled to said execution decode unit for analyzing the collected execution characteristics.

19. A system according to claim 18 wherein said execution analysis unit compares the decoded execution characteristics to the code being executed by said processor circuitry.

20. A system according to claim 18 wherein said external tester further comprises an execution control unit coupled to said execution unit and to said execution decode unit.

21. A method for testing an electronic device comprising an integrated circuit processor, the integrated circuit processor comprising processor circuitry, and an execution coupled to the processor circuitry, the method comprising:
temporarily coupling an external tester to the execution unit; and
using the external tester to collect a plurality of execution characteristics while the processor circuitry executes a dedicated code to thereby test the dedicated code.

22. A method according to claim 21 wherein the external tester collects the plurality of execution characteristics in realtime.

23. A method according to claim 21 wherein the integrated circuit processor further comprises a program memory for storing the dedicated code.

24. A method according to claim 21 wherein the electronic device further comprises a program memory for storing the dedicated code.

25. A method according to claim 21 wherein the processor circuitry comprises a plurality of registers; and wherein the execution unit accesses the plurality of registers.

26. A method according to claim 21 wherein the execution unit comprises at least one register output and an address bus output; and wherein the external tester is temporarily coupled thereto.

27. A method according to claim 26 wherein the address bus output provides an address corresponding to an instruction being executed, and the at least one register output provides a flag corresponding to the instruction being executed.

28. A method according to claim 21 wherein the external tester comprises an execution decode unit for decoding the collected execution characteristics; and an execution analysis unit coupled to the execution decode unit for analyzing the collected execution characteristics.

29. A method according to claim 28 wherein the execution analysis unit compares the decoded execution characteristics to the code being executed by the processor circuitry.
